(19) United States
(12) Patent Application Publication
(10) Pub. No.: US 2017/0081588 A1
(43) Pub. Date: Mar. 23, 2017

(54) LIQUID CRYSTAL COMPOSITION AND LIQUID CRYSTAL DISPLAY DEVICE INCLUDING THE SAME

(71) Applicant: Samsung Display Co. Ltd., Yongin-city (KR)

(72) Inventors: Su Jung Huh, Yongin-si (KR); Yeon Mun Jeon, Hwaseong-si (KR)

(21) Appl. No.: 15/002,638

(22) Filed: Jan. 21, 2016

(30) Foreign Application Priority Data
Sep. 18, 2015 (KR) 10-2015-0132026

(51) Int. Cl. C09K 19/30; G02F 1/1362; G02F 1/1343

(52) U.S. Cl. CPC C09K 19/3003; G02F 1/134309; G02F 1/136286; G02F 2001/134345; C09K 2019/3004; C09K 2019/3009; C09K 2019/301; C09K 2019/3016

(57) ABSTRACT

A liquid crystal display device includes: a first substrate including a plurality of pixel areas; a first sub-pixel electrode disposed in a first pixel area on the first substrate; a second sub-pixel electrode disposed in the first pixel area on the first substrate and spaced apart from the first sub-pixel electrode, and a polarity of a voltage applied to the second sub-pixel electrode with reference to a common voltage is different from a polarity of a voltage applied to the first sub-pixel electrode with reference to the common voltage; a second substrate facing the first substrate and spaced apart from the first substrate; and a liquid crystal layer which interposed between the first substrate and the second substrate and including a liquid crystal composition having dielectric anisotropy of about −2.5 to about −1.5.

This application claims priority to Korean Patent Application No. 10-2015-0132026, filed on Sep. 18, 2015, and all the benefits accruing therefrom under 35 U.S.C. §119, the content of which in its entirety is herein incorporated by reference.

### BACKGROUND OF THE INVENTION

1. Field of the Invention

The present invention relates to a liquid crystal composition and a liquid crystal display device including the same.

2. Description of the Related Art

A liquid crystal display device is one type of widely used flat panel display devices. The liquid crystal display includes two substrates including a field generating electrode, such as a pixel electrode, and a common electrode, and a liquid crystal layer interposed between the two substrates.

The liquid crystal display device applies a voltage to the field generating electrode to generate an electric field in the liquid crystal layer. The electric field determines the orientation direction of the liquid crystals in the liquid crystal layer, and displays an image by controlling the polarization of incident light.

Meanwhile, along with diversification of the application of the liquid crystal display device, it is desirable that the liquid crystal display device possess various characteristics, such as low-voltage drive, high-voltage maintenance ratio, wide viewing angle characteristics, improved contrast, a wide operating temperature range and high-speed response. Attempts have been made to improve the above-mentioned characteristics of the liquid crystal display device, in particular, by controlling the physical properties of the liquid crystal composition included in the liquid crystal layer.

### SUMMARY

The liquid crystal molecules used in a liquid crystal display device, in particular, a transverse electric field liquid crystal display device, may have a positive dielectric anisotropy or a negative dielectric anisotropy. When the liquid crystal molecules in the liquid crystal display device have negative dielectric anisotropy, there is an advantage in that transmittance and contrast are higher than a liquid crystal display device including liquid crystal molecules having positive dielectric anisotropy.

Meanwhile, since fluorine substituents contained in the liquid crystal molecules with negative dielectric anisotropy have a high electronegativity, there is an increased attractive force between the liquid crystal molecules which induces a smectic phase capable of easily inducing crystallization of the liquid crystal molecules. Thus, these types of liquid crystal molecules have characteristics in which the viscosity of liquid crystal compositions increase, the response speed is reduced, and the low-temperature margin is disadvantageous.

Thus, an aspect of the present invention provides a liquid crystal composition which has low viscosity and a low low-temperature margin.

Another aspect of the present invention provides a liquid crystal display device which has an improved response speed, a wide operating temperature range, and low power consumption.

Further, still another aspect of the present invention provides a liquid crystal display device in which the transmittance and the contrast are improved, and a display quality is also improved.

According to an exemplary embodiment, there is provided a liquid crystal display device which includes a first substrate having a plurality of pixel areas; a first sub-pixel electrode disposed in a first pixel area on the first substrate; a second sub-pixel electrode disposed in the first pixel area on the first substrate and spaced apart from the first sub-pixel electrode, and in which a polarity of a voltage applied to the second sub-pixel electrode with reference to a common voltage is different from a polarity of a voltage applied to the first sub-pixel electrode with reference to the common voltage; a second substrate facing the first substrate and spaced apart from the first substrate; and a liquid crystal layer interposed between the first substrate and the second substrate and including a liquid crystal composition having dielectric anisotropy of about −2.5 to about −1.5.

In an exemplary embodiment, the liquid crystal display device may further include a common electrode disposed on the second substrate and facing the first sub-pixel electrode and the second sub-pixel electrode and to which the common voltage is applied, the liquid crystal layer interposed between the common electrode and the first and second electrode, and an absolute value of the electric field between the first sub-pixel electrode and the common electrode may be the same as an absolute value of the electric field between the second sub-pixel electrode and the common electrode.

In an exemplary embodiment, the liquid crystal display device may further include: at least one first gate line disposed between the first substrate and the first sub-pixel electrode and extending in one direction; at least one second gate line disposed between the first substrate and the first sub-pixel electrode and extending in the one direction; and a plurality of data lines disposed between the first substrate and the first sub-pixel electrode, the plurality of data lines including a first data line, a second data line, and a third data line each intersecting the first gate line and the second gate line, and where the plurality of data lines are electrically insulated.

In an exemplary embodiment, the first sub-pixel electrode may be electrically connected to the first gate line and the first data line, and the second sub-pixel electrode may be electrically connected to the first gate line and the second data line.

In an exemplary embodiment, the polarity of the voltage applied to the first data line with reference to the common voltage may be different from the polarity of the voltage applied to the second data line with reference to the common voltage, in a single frame interval.

In an exemplary embodiment, the liquid crystal display device may further include: a third sub-pixel electrode disposed in a second pixel area on the first substrate, the second pixel area different from the first pixel area, wherein the third sub-pixel electrode is electrically connected to the second gate line and the second data line.

In an exemplary embodiment, the liquid crystal display device may further include: a fourth sub-pixel electrode disposed in the second pixel area on the first substrate and spaced apart from the third sub-pixel electrode, where a polarity of voltage applied to the fourth sub-pixel electrode is different from a polarity of the voltage applied to the third sub-pixel electrode with respect to the reference voltage, where the fourth sub-pixel electrode may be electrically connected to the second gate line and the third data line.

In an exemplary embodiment, the polarity of the voltage applied to the second data line with reference to the common voltage may be different from the polarity of the voltage applied to the third data line with reference to the common voltage, in a single frame interval.

According to an exemplary embodiment, there is provided a liquid crystal display device which includes: a first substrate including a plurality of pixel areas; a first electrode disposed in a first pixel area on the first substrate; a second substrate facing the first substrate and spaced apart from the first substrate; a second electrode disposed on the second substrate; and a liquid crystal layer interposed between the first substrate and the second substrate and including a liquid crystal composition having dielectric anisotropy of about −2.5 to about −1.5 and refractive index anisotropy of about 0.090 to about 0.120.

In an exemplary embodiment, the liquid crystal display device may have a cell gap in a range of about 2.8 μm to about 3.4 μm.

In an exemplary embodiment, the liquid crystal composition may contain a compound represented by following Chemical Formula 1 in an amount of about 10 weight percent to about 30 weight percent based on an entire weight of the liquid crystal composition.

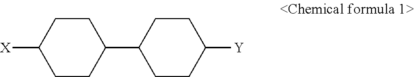

Where, in chemical formula 1, each of X and Y is independently an alkyl group having one to ten carbon atoms, an alkenyl group having two to ten carbon atoms, an alkoxyl group having one to ten carbon atoms, a fluoroalkyl group having one to ten carbon atoms, a fluoroalkenyl group having two to ten carbon atoms or a fluoroalkoxy group having one to ten carbon atoms.

In an exemplary embodiment, the liquid crystal composition may further contain a compound represented by the following Chemical Formula 2 in an amount of about 0.01 weight percent to about 10 weight percent based on the entire weight of the liquid crystal composition.

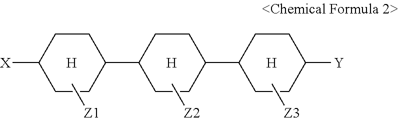

Where, in Chemical Formula 2, each of X and Y is independently an alkyl group having one to ten carbon atoms, an alkenyl group having two to ten carbon atoms, an alkoxyl group having one to ten carbon atoms, a fluoroalkyl group having one to ten carbon atoms, a fluoroalkenyl group having two to ten carbon atoms or a fluoroalkoxy group having one to ten carbon atoms,

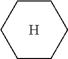

is a cyclohexyl group or a phenyl group, at least two of

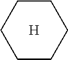

are a phenyl group, and at least one of the at least two phenyl groups has one or more hydrogen group replaced with a fluorine group, each of Z1, Z2, and Z3 is independently a hydrogen group or a fluorine group.

In an exemplary embodiment, the liquid crystal composition may further contain a compound represented by the following Chemical Formula 3 in an amount of about 0.001 weight percent to about 5 weight percent based on an entire weight of the liquid crystal composition.

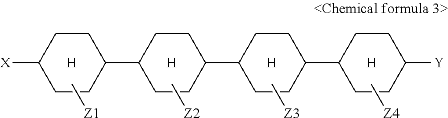

Wherein, in Chemical Formula 3, each of X and Y is independently an alkyl group having one to ten carbon atoms, an alkenyl group having two to ten carbon atoms, an alkoxyl group having one to ten carbon atoms, a fluoroalkyl group having one to ten carbon atoms, a fluoroalkenyl group having two to ten carbon atoms or a fluoroalkoxy group having one to ten carbon atoms,

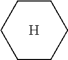

is a cyclohexyl group or a phenyl group, at least one

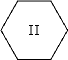

is a phenyl group, and one or more hydrogen group of the at least one phenyl group is replaced with a fluorine group, and each of Z1, Z2, Z3, and Z4 is independently a hydrogen group or a fluorine group.

According to an exemplary embodiment, there is provided a liquid crystal composition having a dielectric anisotropy of about −1.5 to about −2.5 and a refractive index anisotropy of about 0.090 to about 0.120.

In an exemplary embodiment, the liquid crystal composition may include: about 10 weight percent to about 30 weight percent of a compound represented by following Chemical Formula 1, based on the total weight of the liquid crystal composition.

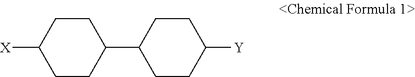

Where, in Chemical Formula 1, each of X and Y is independently an alkyl group having one to ten carbon atoms, an alkenyl group having two to ten carbon atoms, an alkoxyl group having one to ten carbon atoms, a fluoroalkyl group having one to ten carbon atoms, a fluoroalkenyl group having two to ten carbon atoms or a fluoroalkoxy group having one to ten carbon atoms.

In an exemplary embodiment, the liquid crystal composition may further include: a compound represented by the following chemical formula 2 in an amount of about 0.01 weight percent to about 10 weight percent based on the entire weight of the liquid crystal composition.

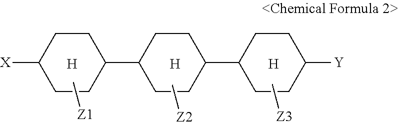

Where, in Chemical Formula 2, each of X and Y is independently an alkyl group having one to ten carbon atoms, an alkenyl group having two to ten carbon atoms, an alkoxyl group having one to ten carbon atoms, a fluoroalkyl group having one to ten carbon atoms, a fluoroalkenyl group having two to ten carbon atoms or a fluoroalkoxy group having one to ten carbon atoms,

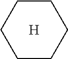

is a cyclohexyl group or a phenyl group at least two of

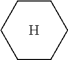

are a phenyl group, and at least one of the at least two phenyl groups has one or more hydrogen group replaced with fluorine group, and each of Z1, Z2, and Z3 is independently a hydrogen group or a fluorine group.

In an exemplary embodiment, the compound represented by the Chemical Formula 2 may be a compound represented by the following Chemical Formula 8.

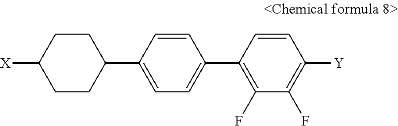

Where, in chemical formula 8, each of X and Y is independently an alkyl group having one to ten carbon atoms, an alkenyl group having two to ten carbon atoms, an alkoxyl group having one to ten carbon atoms, a fluoroalkyl group having one to ten carbon atoms, a fluoroalkenyl group having two to ten carbon atoms or a fluoroalkoxy group having one to ten carbon atoms.

In an exemplary embodiment, the liquid crystal composition may further include: a compound represented by following Chemical Formula 3 in an amount of about 0.001 weight percent to about 5 weight percent based on the entire weight of the liquid crystal composition.

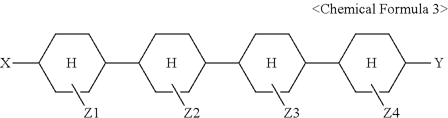

Where, in Chemical Formula 3, each of X and Y is independently an alkyl group having one to ten carbon atoms, an alkenyl group having two to ten carbon atoms, an alkoxyl group having one to ten carbon atoms, a fluoroalkyl group having one to ten carbon atoms, a fluoroalkenyl group having two to ten carbon atoms or a fluoroalkoxy group having one to ten carbon atoms,

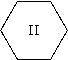

is a cyclohexyl group or a phenyl group, at least one

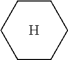

is a phenyl group, and one or more hydrogen group of the at least one phenyl group is replaced with a fluorine group, and each of Z1, Z2, Z3, and Z4 is independently a hydrogen group or a fluorine group.

In an exemplary embodiment, the compound represented by Chemical Formula 3 may be a compound represented by following Chemical Formula 12.

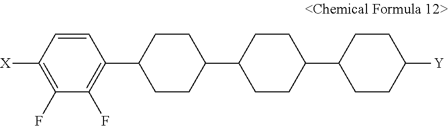

Where, in Chemical Formula 12, each of X and Y is independently an alkyl group having one to ten carbon atoms, an alkenyl group having two to ten carbon atoms, an alkoxyl group having one to ten carbon atoms, a fluoroalkyl group having one to ten carbon atoms, a fluoroalkenyl group having two to ten carbon atoms or a fluoroalkoxy group having one to ten carbon atoms.

In an exemplary embodiment, the liquid crystal composition may include: a low margin temperature in a range of about −40° C. to about −20° C., and a high margin temperature in a range of about 90° C. to about 100° C.

Embodiments of the invention provided at least one of the following advantages.

According to an exemplary embodiment, there is provided a liquid crystal composition having wide temperature range to maintain the nematic phase and low viscosity by having a relatively small dielectric anisotropy.

According to an exemplary embodiment, there is provided a liquid crystal display having a wide operating temperature range without high power consumption, which can be applied to various fields of display device.

Also, since the transmittance and contrast of the liquid crystal display device are good, and the response speed is improved, the display quality is also improved.

However, the effects of the invention are not restricted to those set forth herein. The above and other effects of the invention will become more apparent to one of skill in the art to which the invention pertains by referencing the claims.

### BRIEF DESCRIPTION OF THE DRAWINGS

The above and other aspects, advantages, and features of this disclosure will become more apparent by describing in further detail exemplary embodiments thereof with reference to the attached drawings, in which:

FIG. 1 is a schematic block diagram of an embodiment of a liquid crystal display device;

FIG. 2 is a plan view of some pixels of the liquid crystal display device of FIG. 1;

FIG. 3 is a cross-sectional view taken along the line of FIG. 2;

FIG. 4 is a comparative diagram comparing the cross-section taken along the line IVb-IVb′ of FIG. 2 with the cross-section taken along the line IVa-Iva′; and

FIG. 5 is a cross-sectional view illustrating the behavior of the liquid crystal molecules in the first pixel area of FIG. 2.

### DETAILED DESCRIPTION

Features of the invention and methods of accomplishing the same may be understood more readily by reference to the following detailed description of preferred embodiments and the accompanying drawings.

The invention may, however, be embodied in many different forms and should not be construed as being limited to the embodiments set forth herein. Rather, these embodiments are provided so that this disclosure will be thorough and complete and will fully convey the concept of the invention to those skilled in the art, and the invention will only be defined by the appended claims.

In the drawings, the thickness of layers and regions are exaggerated for clarity. It will be understood that when an element or layer is referred to as being “on,” “connected to” or “coupled to” another element or layer, the element or layer can be directly on, connected or coupled to another element or layer or intervening elements or layers. In contrast, when an element is referred to as being “directly on,” “directly connected to” or “directly coupled to” another element or layer, there are no intervening elements or layers present. As used herein, connected may refer to elements being physically, electrically and/or fluidly connected to each other.

Like numbers refer to like elements throughout. As used herein, the term “and/or” includes any and all combinations of one or more of the associated listed items.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the invention.

Spatially relative terms, such as “below,” “lower,” “under,” “above,” “upper” and the like, may be used herein for ease of description to describe the relationship of one element or feature to another element(s) or feature(s) as illustrated in the figures. It will be understood that the spatially relative terms are intended to encompass different orientations of the device in use or operation, in addition to the orientation depicted in the figures. For example, if the device in the figures is turned over, elements described as “below” or “beneath” relative to other elements or features would then be oriented “above” relative to the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used in this specification, specify the presence of stated features, integers, operations, elements, and/or components, but do not preclude the presence or addition of one or more other features, integers, steps, operations, elements, components, and/or groups thereof.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10%, 5% of the stated value.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

Hereinafter, embodiments of the invention will be described with reference to the attached drawings.

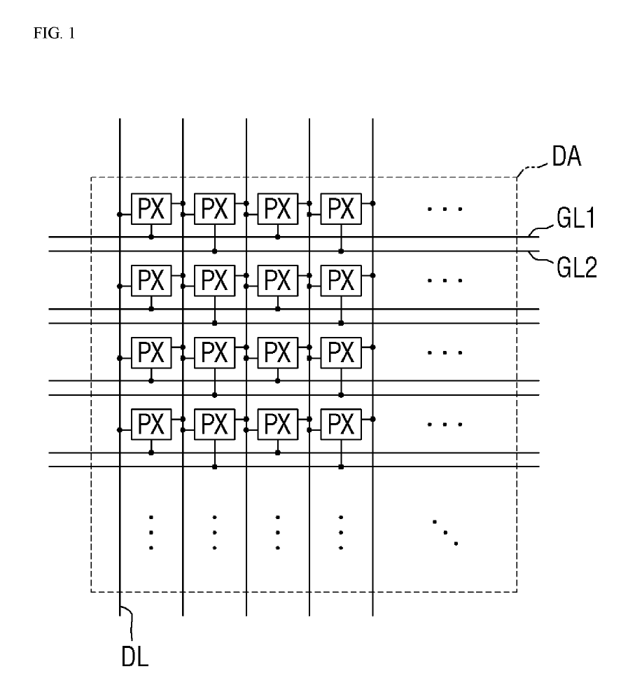

FIG. 1 is a schematic block diagram of an embodiment of a liquid crystal display device.

Referring to FIG. 1, an embodiment of a liquid crystal display device a display area DA and a non-display area (not illustrated). The display area DA is an area in which an image is visible, and the non-display area (not illustrated) is an area in which no image is visible. The outline of the display area DA is surrounded by the non-display area (not illustrated).

The display area DA includes a plurality of first gate lines GL1 extending in one direction (e.g., a row direction), a plurality of second gate lines GL2 extending in the one direction, a plurality of data lines DL extending in the other direction (e.g., a column direction) intersecting with the one direction, and a plurality of pixel areas PX formed in an area in which the first and second gate lines GL1, GL2 and the data line DL intersect with one another. The plurality of pixel areas PX may be arranged in the row direction and in the column direction and may be disposed in a substantially matrix shape.

Each pixel area PX may uniquely display one color of the primary colors to achieve the color display. Examples of the primary colors may include red, green and blue.

The non-display area (not illustrated) may be a light blocking area. In the non-display area of the liquid crystal display device, a gate driver (not illustrated) that provides a gate signal to the pixel areas PX of the display area DA, and a data driver that provides a data signal (not illustrated), may be disposed. The first gate lines GL1, the second gate lines GL2, and the data lines DL extend from the display area DA to the non-display area, and may be electrically connected to the respective drive units.

The gate driver may generate a first gate signal and a second gate signal capable of activating each pixel area PX of the display area DA depending on the gate driver control signal, and may transmit the first and second gate signals to the corresponding first gate line GL1 and the second gate line GL2.

Further, the data driver may generate a data signal, including a data voltage depending on a video data signal and the data driver control signal, and may transmit the data signal to the corresponding data line DL. The data voltage may change in polarity for each frame.

Hereinafter, an embodiment of the pixels constituting the liquid crystal display device will be described in detail.

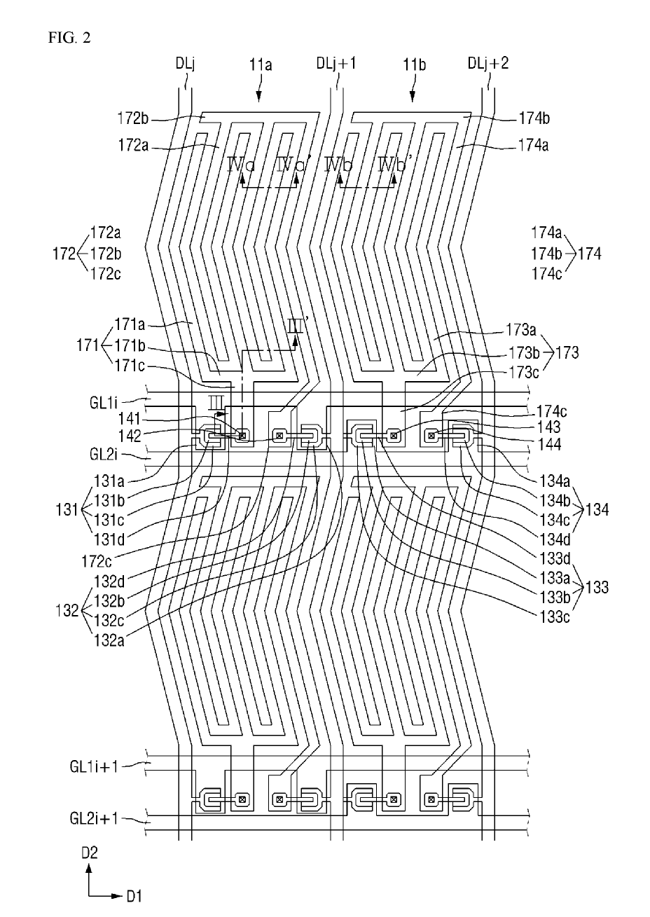

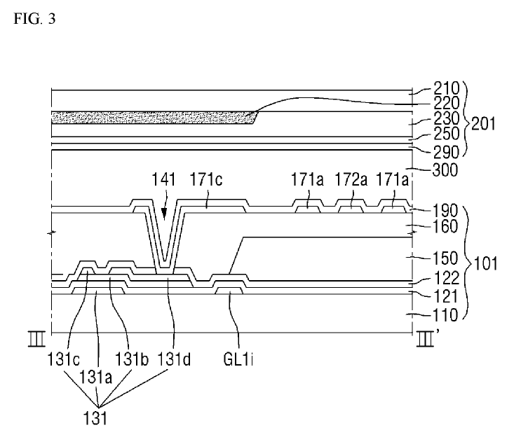

FIG. 2 is a plan view of some of the pixels of the liquid crystal display device of FIG. 1. FIG. 3 is a cross-sectional view taken along line of FIG. 2.

FIG. 2 illustrates four pixel areas among the plurality of pixel areas arranged in a matrix shape. The four pixel areas include a first pixel area 11a and a second pixel area 11b. Other pixel areas which are not illustrated in FIG. 2 include the same column as the first pixel area 11a and have substantially the same configuration and arrangement as the first pixel area 11a, while other pixel areas include the same column as the second pixel area 11b and may have substantially the same configuration and arrangement as the second pixel area 11b. Further, the pixel areas constituting a single row may be repeatedly disposed, while the first pixel area 11a and the second pixel area 11b form a basic unit.

Referring to FIGS. 2 and 3, the first substrate 101 may include a first base substrate 110, one or more thin film transistors 131, 132, 133, 134, a color filter 150, one or more sub-pixel electrodes 171, 172, 173, 174, a first alignment film 190, a plurality of protective films/insulation films, and the like.

The first base substrate 110 is a transparent insulating substrate which may be formed of substances having excellent permeability, heat resistance and chemical resistance. For example, the first base substrate 110 may be a silicon substrate, a glass substrate, or a plastic substrate.

A gate wiring layer is disposed on the first base substrate 110. The gate wiring layer includes a plurality of first gate lines GL1i, GLli+1, a plurality of second gate lines GL2i, GL2i+1, and a plurality of gate electrodes 131a, 132a, 133a, 134a.

The first gate line GL1i extends approximately along a first direction D1. The first gate electrode 131a protrudes downward from the first gate line GL1i and may be integrally formed without a physical boundary to each other. Also, the second gate electrode 132a protrudes downward from the first gate line GL1i and is integrally formed, but may be located on the right side of the first gate electrode 131a. A first gate signal provided from the first gate line GL1i may be applied to the first and second gate electrodes 131a, 132a. Similarly, the second gate line GL2i extends approximately along the first direction D1 substantially in parallel to the first gate line GL1i. The third gate electrode 133a protrudes upward from the second gate line GL2i and may be integrally formed without a physical boundary to each other. Further, the fourth gate electrode 134a protrudes upward from the second gate line GL2i and is integrally formed, but may be located on the right side of the third gate electrode 133a. A second gate signal provided from the second gate line GL2i may be applied to the third and fourth gate electrodes 133a, 134a.

The gate wiring layer may be formed by patterning a first metal layer containing an element selected from one or more of tantalum (Ta), tungsten (W), titanium (Ti), molybdenum (Mo), aluminum (Al), copper (Cu), silver (Ag), chromium (Cr) or neodymium (Nd), or an alloy material, or a compound mainly containing the element, after formation of the first metal layer. The patterning may be performed, using a mask process, and using other methods known to be capable of forming a pattern.

A gate insulating film 121 is disposed on the gate wiring layer and over the entire surface of the first base substrate 110. The gate insulating film 121 is made of an electrically insulating material, and may electrically insulate the layer located thereon and the layer located below it from each other. Examples of the material forming the gate insulating film 121 may include one or more of silicon nitride (SiNx), silicon oxide (SiOx), silicon nitride oxide (SiNxOy), and silicon oxynitride (SiOxNy). The gate insulating film may be formed of a multi-film structure which includes at least two insulating layers having different physical properties.

A semiconductor material layer is disposed on the gate insulating film 121. The semiconductor material layer includes a plurality of semiconductor layers 131b, 132b, 133b, 134b. The first semiconductor layer 131b may be at least partially disposed in an area in which it is superimposed with the first gate electrode 131a. The first semiconductor layer 131b performs the role of a channel in the thin film transistor, and may turn on or turn off the channel depending on the voltage provided to the gate electrode. Similarly, the second semiconductor layer 132b is at least partially disposed in an area in which it is superimposed with the second gate electrode 132a, the third semiconductor layer 133b is at least partially disposed in an area in which it is superimposed with the third gate electrode 133a, and the fourth semiconductor layer 134b may be at least partially disposed in an area in which it is superimposed with the fourth gate electrode 134a.

The semiconductor material layer may be formed by patterning a semiconductor material layer including a semiconductor material, such as amorphous silicon, polycrystalline silicon, or an oxide semiconductor.

A data wiring layer is disposed on the semiconductor material layer. The data wiring layer includes a plurality of data lines DLj, DLj+1, DLj+2, a plurality of source electrodes 131c, 132c, 133c, 134c and a plurality of drain electrodes 131d, 132d, 133d, 134d.

The first data line DLj extends approximately along the second direction D2 to intersect with the first and second gate lines GL1i, GL2i. In addition, the second data line DLj+1 and the third data line DLj+2 also extend approximately along the second direction D2 substantially in parallel to the first data line DLj to intersect with the first and second gate lines GL1i, GL2i. The first to third data signals may be applied to each of the first to third data lines DLj, DLj+1, DLj+2.

A plurality of pixel areas 11a, 11b is defined in an area surrounded by the plurality of first and second gate lines GL1i, GL2i and the plurality of data lines DLj, DLj+1, DLj+2. The plurality of each of the pixel areas 11a, 11b may be areas which are independently operated by a plurality of thin film transistors 131, 132, 133, 134 connected by the adjacent first and second gate lines and the data lines.

The first source electrode 131c and the first drain electrode 131d are disposed on the first gate electrode 131a and the first semiconductor layer 131b so as to be spaced apart from each other. The first source electrode 131c may have a shape that at least partially surrounds the first drain electrode 131d. For example, the first source electrode may have a C-shape, a U-shape, an inverted C-shaped, or an inverted U-shape. The first source electrode 131c protrudes to the right side from the first data line DLj and may be integrally formed with the first data line DLj without a physical boundary. The first drain electrode 131d may be electrically connected to the first sub-pixel electrode 171 in the first pixel area 11a.

Further, the second source electrode 132c and the second drain electrode 132d are disposed on the second gate electrode 132a and the second semiconductor layer 132b so as to be spaced apart from each other. The second source electrode 132c protrudes to the left from the second data line DLj+1 and may be integrally formed with the second data line DLj+1. The second drain electrode 132d may be electrically connected to the second sub-pixel electrode 172 in the first pixel area 11a.

Further, the third source electrode 133c and the third drain electrode 133d are disposed on the third gate electrode 133a and the third semiconductor layer 133b so as to be spaced apart from each other. The third source electrode 133c protrudes to the right side from the second data line DLj+1 and may be integrally formed with the second data line DLj+1. The third drain electrode 133d may be electrically connected to the third sub-pixel electrode 173 in the second pixel area 11b.

Furthermore, the fourth source electrode 134c and the fourth drain electrode 134d are disposed on the fourth gate electrode 134a and the fourth semiconductor layer 134b so as to be spaced apart from each other. The fourth source electrode 134c protrudes to the left side from the third data line DLj+2 and may be integrally formed with the third data line DLj+2. The fourth drain electrode 134d may be electrically connected to the fourth sub-pixel electrode 174 in the second pixel area 11b.

The data wiring layer may be formed by patterning a second metal layer. The second metal layer may include a refractory metal, such as silver (Ag), gold (Au), copper (Cu), nickel (Ni), platinum (Pt), palladium (Pd), iridium (Ir), rhodium (Rh), tungsten (W), aluminum (Al), tantalum (Ta), molybdenum (Mo), cadmium (Cd), zinc (Zn), iron (Fe), titanium (Ti), silicon (Si), germanium (Ge), zirconium (Zr), or barium (Ba), or alloys thereof, or the second metal layer containing the metal nitride, after formation of the second metal layer.

An ohmic contact layer (not illustrated) may be disposed between the semiconductor material layer and the data wiring layer. The ohmic contact layer may contain an n+ hydrogenated amorphous silicon material doped with n-type impurity at a high concentration or may contain silicide.

Each of the first to fourth gate electrodes 131a, 132a, 133a, 134, the first to fourth semiconductor layers 131b, 132b, 133b, 134b, the first to fourth source electrodes 131c, 132c, 133c, 134c, and the first to fourth drain electrodes 131d, 132d, 133d, 134d constitutes a thin film transistor which is a three terminal element.

A protective film 122 is disposed on the data wiring layer and over the entire surface of the first base substrate 110. The protective film 122 may be formed of an organic film and/or an inorganic film and may have a single film or multi-film structure. The protective film 122 may prevent wirings formed below, or the semiconductor layer of the thin film transistor, from being exposed and coming into direct contact with the organic material.

A color filter 150 may be disposed on the protective film 122 in the area superimposed with the pixel area. The color filter 150 may allow light of a specific wavelength band to selectively pass therethrough. The color filter 150 may be disposed between the two adjacent data lines, and color filters that allow light of different wavelength bands to pass may be disposed in different pixel areas adjacent to each other. For example, a red color filter may be disposed in the first pixel area, and a green color filter may be disposed in the second pixel area adjacent to the first pixel area.

Although FIG. 3 illustrates a color filter-on array in which the color filter 150 is disposed on the first substrate 101, in some embodiments, an array-on color filter structure in which the color filter is formed below the thin film transistor may be adopted, or alternatively, the color filter may be disposed on the second substrate.

An insulating layer 160 is disposed on the color filter 150 over the entire surface of the protective film 122. The insulating layer 160 may contain an organic material. The insulating layer 160 may make the heights of the plurality of components laminated on the first base substrate 110 uniform.

Contact holes 141, 142, 143, and 144 are formed in the protective film 122 and the insulating layer 160 so that the first to fourth drain electrodes 131d, 132d, 133d, 134d are partially exposed. The first to fourth drain electrodes 131d, 132d, 133d, 134d may be electrically connected to each of the first to fourth sub-pixel electrodes 171, 172, 174 through the first to fourth contact holes 141, 142, 143, 144.

The first sub-pixel electrode 171 and the second sub-pixel electrode 172 may be disposed on the top of the insulating layer 160 in the first pixel area 11a and on the top of the first and second drain electrodes 131d, 132d exposed by the first and second contact holes 141, 142. Similarly, the third sub-pixel electrode 173 and the fourth sub-pixel electrode 174 may be disposed on the top of the insulating layer 160 in the second pixel area 11b and on the top of the third and fourth drain electrodes 133d, 134d exposed by the third and fourth contact holes 143, 144. Although FIG. 3 illustrates a case where the first sub-pixel electrode 171 and the second sub-pixel electrode 172 are disposed on the same layer, as an alternative to the illustrated configuration, a predetermined insulation layer may be disposed on the first sub-pixel electrode, and the second sub-pixel electrode may be disposed on the insulating layer.

The first to fourth sub-pixel electrodes 171, 172, 173, 174 may be transparent electrodes formed by patterning the third metal layer. Examples of a material which forms the third metal layer may include, but not limited to, indium tin oxide (ITO), indium zinc oxide (IZO) or the like.

The first sub-pixel electrode 171 in one pixel area, e.g., the first pixel area 11a, may form a fringe field together with the second sub-pixel electrode 172 disposed in the same pixel area and a common electrode 250 (to be described later), thereby controlling the liquid crystal molecules in the liquid crystal layer 300.

The first sub-pixel electrode 171 includes a plurality of first branch electrode sections 171a, a first connection electrode section 171b which connects at least one end of the plurality of first branch electrode sections 171a, and a first protrusion electrode section 171c, which protrudes from the first connection electrode section 171b in the direction of the first contact hole 141.

The first branch electrode section 171a may have a bar shape that is symmetrically bent on the basis of the substantially central portion of the first pixel area 11a. The directions of the major fringe field may be differently formed on the upper side and the lower side on the basis of the central portion of the first pixel area 11a by the first sub-pixel electrode 171 having the bar-shaped structure, and accordingly, two domains may be formed in a single pixel area. The movement of the liquid crystal molecules in different domains differs within a single pixel area, and as a result, the arrangement of the long axis of the liquid crystal molecules becomes different, and thus, the color shift phenomenon observed at a particular orientation angle may be reduced.

The first protrusion electrode section 171c is electrically connected to the first drain electrode 131d through the first contact hole 141 to receive the provision of the data voltage transmitted from the first data line DLj. The first connection electrode section 171b serves to connect the first protrusion electrode section 171c with the plurality of first branch electrode sections 171a.

Further, the second sub-pixel electrode 172 includes a plurality of second branch electrode sections 172a, a second connection electrode section 172b connecting at least one of the plurality of second branch electrode sections 172a to each other, and a second protrusion electrode section 172c which protrudes from at least one of the plurality of second branch electrode sections 172a in the direction of the second contact hole 142.

The second branch electrode section 172a is disposed between the two adjacent first electrode sections 171a, and may have a shape corresponding to the first branch electrode section 171a. That is, on a section perpendicular to the extension direction of the first and second branch electrode sections 171a, 172a, the first branch electrode section 171a and the second branch electrode section 172a may be arranged in a mutually alternating manner. Further, the first electrode section 171a and the second branch electrode section 172a may receive the provision of the data voltages having different polarities from each other.

The first sub-pixel electrode 171 and the second sub-pixel electrode 172 having such an arrangement form an electric field together with the common electrode 250, and may mutually form an electric field. Thus, control of the liquid crystals is improved, and there is an added effect of being able to reduce the driving voltage of the liquid crystal display device.

Meanwhile, the second protrusion electrode section 172c is electrically connected to the second drain electrode 132d through the second contact hole 142 to receive the provision of the data voltage transmitted from the second data line DLj+1. The second connection electrode section 172b serves to connect the second protrusion electrode section 172c with the plurality of second branch electrode sections 172a.

Similarly, the third sub-pixel electrode 173 in the second pixel area 11b may form a fringe field together with the fourth sub-pixel electrode 174 and the common electrode 250 disposed in the same pixel area. Each of the third sub-pixel electrode 173 and the fourth sub-pixel electrode 174 may have substantially the same shape and arrangement as those of the first sub-pixel electrode 171 and the second sub-pixel electrode 172.

Thus, the third sub-pixel electrode 173 is connected to the second data line DLj+1 to receive the provision of the same data voltage as the second sub-pixel electrode 172, and the fourth sub-pixel electrode 174 may receive the provision of the data voltage transmitted from the third data line DLj+2.

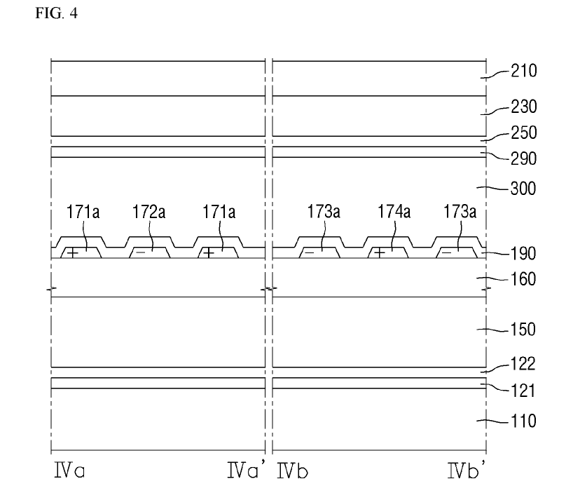

FIG. 4 is a comparative diagram comparing the cross-section taken along line IVa-IVa′ with the cross-section taken along the IVb-IVb′ of FIG. 2, which shows the cross-sectional view illustrating the polarity of the voltage applied to the first to fourth sub-pixel electrodes 171, 172, 173, 174 in a single frame interval.

As described above, the first sub-pixel electrode 171 in the first pixel area 11a is electrically connected to the first gate line GL1i and the first data line DLj, the second sub-pixel electrode 172 in the first pixel area 11a is electrically connected to the first gate line GL1i and the second data line DLj+1, the third sub-pixel electrode 173 in the second pixel area 11b is electrically connected to the second gate line GL2i and the second data line DLj+1, and the fourth sub-pixel electrode 174 in the second pixel area 11b is electrically connected to the second gate line GL2i and the third data line DLj+2.

As illustrated in FIG. 4, the data voltage applied to the data lines forming the odd-numbered rows in a single frame interval, for example, the first data voltage and the third data voltage applied to the first data line DLj and the third data line DLj+2, have the same polarity with respect to the common voltage (i.e. the reference voltage) applied to the common electrode 250, and the data voltage applied to the data lines adjacent to each other, for example, the first data voltage and second data voltage applied to the first data line DLj and the second data line DLj+1, respectively, may have different polarities from each other with respect to the common voltage.

In operation of the pixel in an arbitrary frame interval, when the first gate signal is applied to the first gate line GL1i in a frame, the first thin film transistor 131 connected thereto is turned on. Thus, the first data voltage having the positive polarity provided from the first data line DLj charges the first sub-pixel electrode 171 through the first thin film transistor 131 which is turned on.

At the same time, the second thin film transistor 132 connected to the first gate line GL1i is also turned on, and thus, the second data voltage having the negative polarity provided from the second data line DLj+1 charges the second sub-pixel electrode 172 through the second TFT 132 which is turned on.

Thus, the data voltages having the different polarities from each other may be charged to the first sub-pixel electrode 171 and the second sub-pixel electrode 172 of the first pixel area 11a in a single frame interval without an additional data line, and a strong electric field may be formed between the first sub-pixel electrode 171 and the second sub-pixel electrode 172.

In addition, when the second gate signal is applied to the second gate line GL2i, the third thin film transistor 133 connected thereto is turned on. Thus, the second data voltage having the negative polarity provided from the second data line DLj+1 charges the third sub-pixel electrode 173 through the third thin film transistor 133 which is turned on.

At the same time, the fourth thin film transistor 134 connected to the second gate line GL2i is also turned on, and thus, the third data voltage having the positive polarity provided from the third data line DLj+2 charges the fourth sub-pixel electrode 174 through the fourth thin film transistor 134 which is turned on.

Thus, data voltages having different polarities from each other may be charged to the third sub-pixel electrode 173 and the fourth sub-pixel electrode 174 of the second pixel area 11b in a single frame interval without an additional data line, and as a result, a strong electric field may be formed between the third sub-pixel electrode 173 and the fourth sub-pixel electrode 174.

In the next frame, the first and third data voltages having the negative polarity are provided to the first and third data lines, and the second data voltage having the positive polarity is provided to the second data line, and this process may be repeated.

That is, the voltages having different polarities may be applied to the plurality of sub-pixel electrodes in a pixel area without adding a separate data line At the same time, by reversing the polarity of the data voltage applied to each data line for each frame interval, it is possible to minimize a flicker phenomenon which can be visually recognized by the viewer.

Meanwhile, a predetermined voltage having a value between the first data voltage and the second data voltage may be applied to the common electrode 250 during a single frame interval.

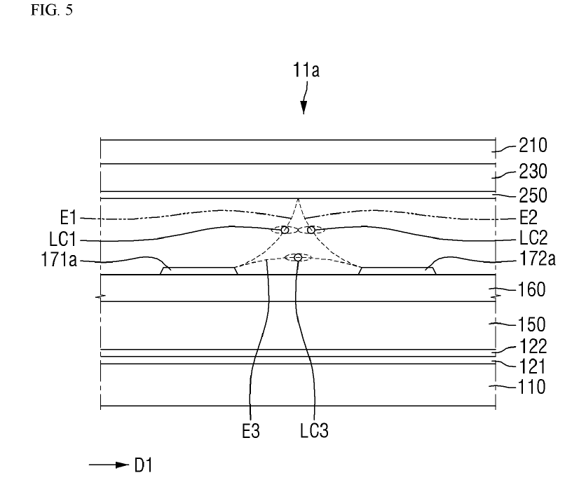

FIG. 5 is a cross-sectional view illustrating the behavior of the liquid crystal molecules in the first pixel area 11a of FIG. 2.

Referring to FIG. 5, the mutually different voltages are applied to the first sub-pixel electrode 171, the second sub-pixel electrode 172, and the common electrode 250 of the first pixel area 11a in the single frame interval. Thus, a first electric field E1 may be formed between the common electrode 250 and the first sub-pixel electrode 171, a second electric field E2 may be formed between the common electrode 250 and the second sub-pixel electrode 172, and a third electric field E3 may be formed between the first sub-pixel electrode 171 and the second sub-pixel electrode 172. In an exemplary embodiment, the absolute value of the first electric field E1 and the absolute value of the second electric field E2 may be the same.

In an initial state in which an electric field is not applied to the liquid crystal layer, the long axes of the liquid crystal molecules LC are oriented parallel to a direction approximately perpendicular to the extension direction of the pixel electrode branch section, i.e., the first direction D1. When the first to third electric fields E1, E2, E3 are formed, the long axes of the liquid crystal molecules may be aligned in a direction perpendicular to the electric field.

Specifically, when the first electric field E1 is formed between the common electrode 250 and the first sub-pixel electrode 171, the liquid crystal molecules LC having the long axes oriented in the first direction D1 near the first electric field E1, are rotated on a plane so that the long axes may be aligned in a direction perpendicular to the first electric field E1. When the second electric field E2 is formed between the common electrode 250 and the second sub-pixel electrode 172, the liquid crystal molecules LC having the long axes oriented in the first direction D1 near the second electric field E2, rotate on a plane so that the long axes may be aligned in a direction perpendicular to the second electric field E2. When the third electric field E3 is formed between the first sub-pixel electrode 171 and the second sub-pixel electrode 172, the liquid crystal molecules LC having the long axes oriented in the first direction D1 near the third electric field E3, rotate on a plane so that the long axes may be aligned in a direction perpendicular to the third electric field E3. Furthermore, liquid crystal molecules adjacent to the liquid crystal molecules rotated by the first to third electric fields E1, E2, and E3, have the same directivity via the collision process between the liquid crystal molecules, and thus the final alignment direction of the liquid crystal molecules in the first pixel area 11a may be determined. Thus, the polarization components of the light incident from a light source (not illustrated) positioned below the liquid crystal display panel change and light passes therethrough. That is, by forming a plurality of electric fields in a single pixel area, it is possible to minimize variation in the alignment of liquid crystal molecules beyond the control force of the electric field, thereby improving control of the alignment of the liquid crystal molecules.

Referring to FIGS. 2 and 3 again, a first alignment film 190 may be formed on the entire surface of the first and second sub-pixel electrodes 171, 172 of the first pixel area 11a and over the entire surface the third and fourth sub-pixel electrodes 173, 174 of the second pixel area 11b. The first alignment film 190 has an anisotropy and may arrange the liquid crystal molecules of the liquid crystal layer 300 which are adjacent to the first alignment film 190, to be aligned in a particular direction relative to the plane of the alignment film. The first alignment film 190 may be a horizontal alignment film.

Subsequently, a second substrate 201 will be described. The second substrate 201 may include a second base substrate 210, a light blocking member 220, an overcoat layer 230, a common electrode 250 and a second alignment film 290.

The second base substrate 210 may be a transparent insulating substrate like the first base substrate 110. The light blocking member 220 is disposed on the second base substrate 210. The light blocking member 220 may be, for example, a black matrix. The light blocking member 220 may be disposed in a boundary area between the plurality of pixel areas, that is, an area superimposed with the data lines, and an area superimposed with the thin film transistor and the plurality of gate lines. That is, a plurality of pixel areas is partitioned by the light blocking member 220 and may prevent a light leakage defect that may occur in a boundary area between the pixel areas.

The overcoat layer 230 is disposed on the light blocking member 220 across the entire surface of the second base substrate 210. The overcoat layer 230 prevents the light blocking member 220 from lifting off of the second base substrate 210, and makes the height of the components laminated on the second base substrate 210 uniform.

The common electrode 250 may be placed on the overcoat layer 230. The common electrode 250 may be a transparent electrode formed by patterning the fourth metal layer. The common electrode 250 may be disposed to overlap most areas except for some areas of each of the pixel areas 11a, 11b. As described above, the common electrode 250 may control the liquid crystal molecules by forming a fringe field together with the first to fourth sub-pixel electrodes 171, 172, 173, 174. The material forming the fourth metal layer may be the same as or different from the material forming the third metal layer. The second alignment film 290 may be disposed on the common electrode 250 over the entire surface.

The first substrate 101 and the second substrate 201 are disposed to maintain a predetermined cell gap and to face each other. In an exemplary embodiment, the cell gap of the liquid crystal display device may be, but is not limited to, about 2.8 μm to about 3.4 μm.

The liquid crystal layer 300 is interposed between the first substrate 101 and the second substrate 201. The liquid crystal layer 300 contains a liquid crystal composition having a negative dielectric anisotropy of about −2.5 to about −1.5. Moreover, the rotational viscosity of the liquid crystal composition may be about 80 millipascals (mPa) to about 110 mPa.

Further, the refractive index anisotropy of the liquid crystal composition may be about 0.090 to about 0.120 or less. By controlling the product (Δnd) of the refractive index anisotropy of the liquid crystal composition, the cell gap of the liquid crystal display device, and the rotational viscosity of the liquid crystal composition, it is possible to improve the response speed of the liquid crystal display device.

In addition, the low margin temperature of the liquid crystal composition may be about −50° C. to about −30° C., and the high margin temperature may be about 90° C. to about 110° C. Since the margin temperature range capable of maintaining the nematic phase of the liquid crystal composition is about −50 to about 110° C., the liquid crystal display device including the liquid crystal composition may ensure a wide operating temperature range.

In addition, the liquid crystal composition may contain a compound represented by the following chemical formula 1 in an amount of about 10 weight percent (wt %) to about 30 weight percent. The liquid crystal composition may further contain a compound represented by the following Chemical Formula 2 in an amount of about 0.01 wt % to about 10 wt %, and may further contain a compound represented by the following Chemical Formula 3 in an amount of about 0.001 wt % to about 5 wt %. The weight percents are based on the entire liquid crystal composition.

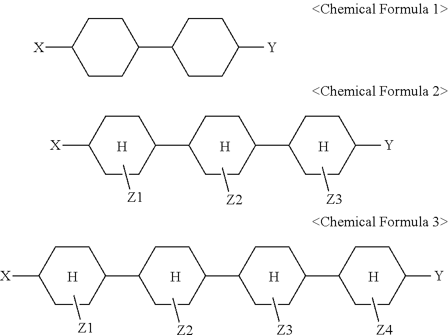

In Chemical Formulas 1 to 3, each of X and Y is independently an alkyl group having one to ten carbon atoms, an alkenyl group having two to ten carbon atoms, an alkoxyl group having one to ten carbon atoms, a fluoroalkyl group having one to ten carbon atoms, a fluoroalkenyl group having two to ten carbon atoms, or a fluoroalkoxy group having one to ten carbon atoms. In Chemical Formulas 2 and 3,

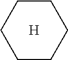

is a cyclohexyl group or a phenyl group. In Chemical Formula 2, each of Z1, Z2, and Z3 is independently a hydrogen group or a fluorine group, at least two of

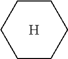

is a phenyl group, and at least one of the at least two phenyl groups has one or more hydrogen group replaced with fluorine groups. In Chemical Formula 3, each of Z1, Z2, Z3, and Z4 is independently a hydrogen group or a fluorine group, at least one of

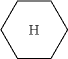

is a phenyl group, and one or more hydrogen group of the at least one phenyl group is replaced with a fluorine group.

Since the fluorine substituents of the liquid crystal molecules contained in the liquid crystal composition induce the negative dielectric anisotropy of the liquid crystal composition, and have a high electronegativity, the fluorine substituents increase the attractive force between the liquid crystal molecules and induce the smetic phase which easily induces crystallization of the liquid crystal molecules. That is, when the absolute value of the dielectric anisotropy is large, the viscosity of the liquid crystal compositions increases, the response speed of the liquid crystal display device is reduced, and a low-temperature margin may be disadvantageous.

In an embodiment, the liquid crystal composition has an effect of being able to maintain the sufficient response speed, since the ranges of low-temperature margin and high-temperature margin capable of maintaining smetic phase are wide and the viscosity is low. This is achieved lowering the relative content of the fluorine substituent in the composition.

Hereinafter, an embodiment of the liquid crystal composition will be described in detail referring to a production example and a comparative example.

### PRODUCTION EXAMPLE AND COMPARATIVE EXAMPLE

The liquid crystal compositions including the listed components and their amounts in the composition (% by weight) were prepared as illustrated in Table 1 below.

TABLE 1

| | Production | Production | Production | Production | Comparative | Comparative |
|---|---|---|---|---|---|---|
| | example 1 | example 2 | example 3 | example 4 | example 1 | example 2 |
| Chemical | 29 | 25 | 22 | 27 | 31 | 38.5 |
| formula 4 | | | | | | |
| Chemical | 14 | 11 | 10 | 6.5 | 12 | 5.5 |
| formula 5 | | | | | | |
| Chemical | 13 | 15 | 13 | 10 | 9 | 16.5 |
| formula 6 | | | | | | |
| Chemical | 10.5 | 10 | 13.5 | 14.5 | 9.5 | 16.5 |
| formula 7 | | | | | | |
| Chemical | 7.5 | 9 | 9.5 | 10 | 9.5 | 13.0 |
| formula 8 | | | | | | |
| Chemical | 11 | 10 | 12 | 17 | 10 | 10 |
| formula 9 | | | | | | |
| Chemical | 13 | 15 | 15 | 10 | 17 | — |
| formula 10 | | | | | | |
| Chemical | — | 5 | 5 | 3 | 4 | — |
| formula 11 | | | | | | |
| Chemical | 2 | — | — | 2 | — | — |
| formula 12 | | | | | | |

Chemical formulas 4 to 12 in Table 1 may be expressed as follows.

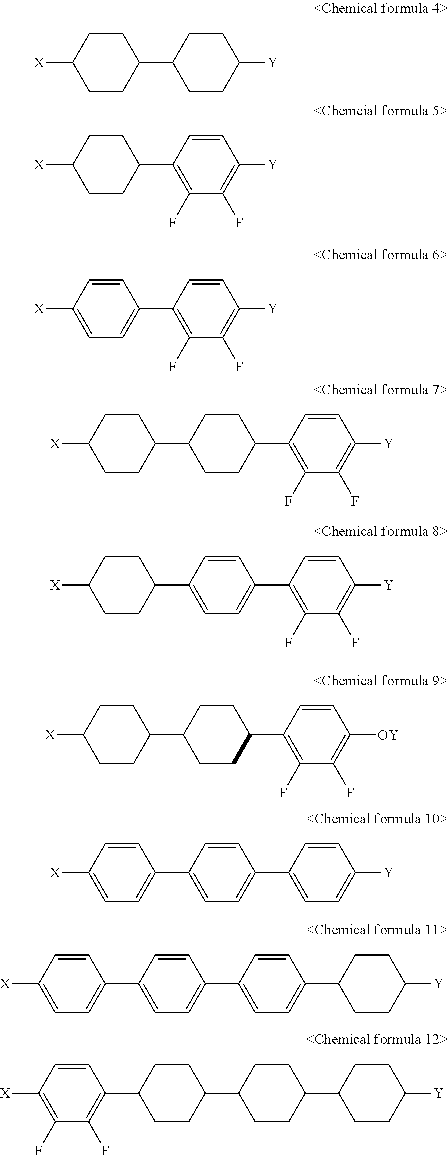

In chemical formulas 4 to 12, each of X and Y is independently an alkyl group having one to ten carbon atoms, an alkenyl group having two to ten carbon atoms, an alkoxyl group having one to ten carbon atoms, a fluoroalkyl group having one to ten carbon atoms, a fluoroalkenyl group having two to ten carbon atoms, or a fluoroalkoxy group having one to ten carbon atoms.

Next, the following experiments were performed using the liquid crystal compositions of production examples 1 to 4 and comparative examples 1 and 2.

### EXPERIMENTAL EXAMPLE 1

### Measurement of Major Physical Properties of Liquid Crystal Composition

The major physical properties of the liquid crystal compositions prepared by production examples 1 to 4 and comparative examples 1 and 2 were determined.

TABLE 2

| | Production | Production | Production | Production | Comparative | Comparative |
|---|---|---|---|---|---|---|
| | example 1 | example 2 | example 3 | example 4 | example 1 | example 2 |
| Δε | −1.5 | −1.6 | −2 | −2.5 | −1.0 | −3.7 |
| Δn | 0.094 | 0.114 | 0.107 | 0.107 | 0.114 | 0.101 |
| γ1(mPa · s) | 86 | 87 | 95 | 102 | 81 | 101 |
| High-temperature | 100 | 100 | 100 | 100 | 100 | 75 |
| margin (° C.) | | | | | | |
| Low-temperature | −40 | −40 | −40 | −40 | −40 | −20 |
| margin (° C.) | | | | | | |

In Table 2, Δε means the dielectric anisotropy of the liquid crystal composition, An means the refractive index anisotropy of the liquid crystal composition, and γ1 means the rotational viscosity having the unit of millipascal second (mPa·s). Further, the high-temperature margin refers to the upper limit temperature of the liquid crystal composition to maintain the nematic phase, and the low-temperature margin refers to the minimum temperature of the liquid crystal composition to maintain the nematic phase.

As shown in Table 2, the liquid crystal composition of production examples 1 to 4 has have a dielectric anisotropy of about −2.5 to about −1.5, and a refractive index anisotropy of about 0.094 to about 0.114. Further, the liquid crystal composition of production examples 1 to 4 has the high margin temperature of about 100° C. and the low-margin temperature of about −40° C., and thus the nematic phase may be maintained across a wide temperature range.

### EXPERIMENTAL EXAMPLE 2

### Measurement of Major Driving Characteristics of Panel

An embodiment of a liquid crystal display device including the liquid crystal composition prepared by production examples 1 to 4 and comparative examples 1 and 2 was manufactured, and the major driving characteristics of the manufactured liquid crystal displays were measured.

TABLE 3

| | Maximum | Response | Drive |
|---|---|---|---|
| | transmittance | rate | voltage |
| | (%) | (ms) | (V) |
| Production | 119 | 25.6 | 6.5 |
| example 1 | | | |
| Production | 124 | 20 | 6.5 |
| example 2 | | | |
| Production | 126 | 25 | 6.0 |
| example 3 | | | |
| Production | 126 | 26.6 | 5.5 |
| example 4 | | | |
| Comparative | 110 | 18.6 | 7.5 |
| example 1 | | | |
| Comparative | 127 | 33 | 5.5 |
| example 2 | | | |

In Table 3, the maximum transmittance is a value (i.e. percentage) obtained by comparing the light transmittance of the liquid crystal display device of the experimental examples with the light transmittance of a reference liquid crystal display device as a comparative target and which is assumed to be 100%.

As shown in Table 3, the liquid crystal display device including the liquid crystal compositions of production examples 1 to 4 has the maximum relative transmittance of about 120% or more and exhibits sufficient transmittance. Also, it is possible to understand that the response speed is about 20 to 25 milliseconds (ms) and that the liquid crystal display device has a relatively excellent response speed. Further, the driving voltage is about 5.5 V to about 6.5 V and thus the low-voltage driving is possible.

Meanwhile, the results show that the liquid crystal display device including the liquid crystal composition of comparative example 1 has a relatively high driving voltage of about 7.5 V, which is not suitable for use in the liquid crystal display device.

Further, the liquid crystal display device including the liquid crystal composition of comparative example 2 has a high response speed of about 33 ms or more, which is not suitable for use in the liquid crystal display device.

While the present invention has been particularly illustrated and described with reference to exemplary embodiments thereof, it will be understood by those of ordinary skill in the art that various changes in form and detail may be made therein without departing from the spirit and scope of the present invention as defined by the following claims. The exemplary embodiments should be considered in a descriptive sense only and not for purposes of limitation.

What is claimed is:

1. A liquid crystal display device comprising:
a first substrate comprising a plurality of pixel areas;
a first sub-pixel electrode disposed in a first pixel area on the first substrate;
a second sub-pixel electrode disposed in the first pixel area on the first substrate and spaced apart from the first sub-pixel electrode, wherein a polarity of a voltage applied to the second sub-pixel electrode with reference to a common voltage is different from a polarity of a voltage applied to the first sub-pixel electrode with reference to the common voltage;
a second substrate facing the first substrate and spaced apart from the first substrate; and
a liquid crystal layer interposed between the first substrate and the second substrate and comprising a liquid crystal composition having dielectric anisotropy of about −2.5 to about −1.5.

2. The liquid crystal display device of claim 1, further comprising:
a common electrode disposed on the second substrate and facing the first sub-pixel electrode and the second sub-pixel electrode and to which the common voltage is applied, the liquid crystal layer being interposed between the common electrode and the first and second sub-pixel electrodes,
wherein an absolute value of an electric field between the first sub-pixel electrode and the common electrode is the same as an absolute value of an electric field between the second sub-pixel electrode and the common electrode.

3. The liquid crystal display device of claim 1, further comprising:
at least one first gate line disposed between the first substrate and the first sub-pixel electrode and extending in one direction;
at least one second gate line disposed between the first substrate and the first sub-pixel electrode and extending in the one direction; and
a plurality of data lines disposed between the first substrate and the first sub-pixel electrode, the plurality of data lines comprising a first data line, a second data line and a third data line each intersecting the first gate line and the second gate line, and wherein each of the plurality of data lines are electrically insulated from each of the plurality of gate lines.

4. The liquid crystal display device of claim 3, wherein the first sub-pixel electrode is electrically connected to the first gate line and the first data line, and
the second sub-pixel electrode is electrically connected to the first gate line and the second data line.

5. The liquid crystal display device of claim 4, wherein the polarity of the voltage applied to the first data line with reference to the common voltage is different from the polarity of the voltage applied to the second data line with reference to the common voltage, in a single frame interval.

6. The liquid crystal display device of claim 4, further comprising:
a third sub-pixel electrode disposed in a second pixel area on the first substrate, the second pixel area different from the first pixel area,
wherein the third sub-pixel electrode is electrically connected to the second gate line and the second data line.

7. The liquid crystal display device of claim 6, further comprising:
a fourth sub-pixel electrode which is disposed in the second pixel area on the first substrate so as to be spaced apart from the third sub-pixel electrode, wherein a polarity of a voltage applied to the fourth sub-pixel electrode with reference to the common electrode is different from a polarity of a voltage applied to the third sub-pixel electrode with reference to the common voltage,
wherein the fourth sub-pixel electrode is electrically connected to the second gate line and the third data line.

8. The liquid crystal display device of claim 7, wherein the polarity of the voltage applied to the second data line with reference to the common voltage is different from the polarity of the voltage applied to the third data line with reference to the common voltage, in a single frame interval.

9. A liquid crystal display device comprising:
a first substrate comprising a plurality of pixel areas;
a first electrode disposed in a first pixel area on the first substrate;
a second substrate facing the first substrate to be spaced apart from the first substrate;
a second electrode disposed on the second substrate; and
a liquid crystal layer interposed between the first substrate and the second substrate and comprising a liquid crystal composition having dielectric anisotropy of about −2.5 to about −1.5 and refractive index anisotropy of about 0.090 to about 0.120.

10. The liquid crystal display device of claim 9, wherein the liquid crystal display device has a cell gap in a range of about 2.8 μm to about 3.4 μm.

11. The liquid crystal display device of claim 9, wherein the liquid crystal composition comprises a compound represented by following Chemical Formula 1 in an amount of about 10 weight percent to about 30 weight percent based on an entire weight of the liquid crystal composition. 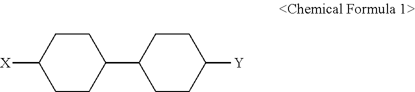
wherein, in Chemical Formula 1, each of X and Y is independently an alkyl group having one to ten carbon atoms, an alkenyl group having two to ten carbon atoms, an alkoxyl group having one to ten carbon atoms, a fluoroalkyl group having one to ten carbon atoms, a fluoroalkenyl group having two to ten carbon atoms, or a fluoroalkoxy group having one to ten carbon atoms.

12. The liquid crystal display device of claim 11, wherein the liquid crystal composition further comprises a compound represented by following Chemical Formula 2 in an amount of about 0.01 weight percent to about 10 weight percent based on the entire weight of the liauid crystal composition. 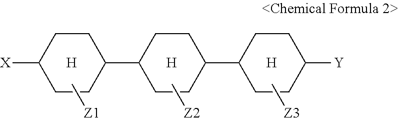
wherein, in Chemical Formula 2, each of X and Y is independently an alkyl group having one to ten carbon atoms, an alkenyl group having two to ten carbon atoms, an alkoxyl group having one to ten carbon atoms, a fluoroalkyl group having one to ten carbon atoms, a fluoroalkenyl group having two to ten carbon atoms or a fluoroalkoxy group having one to ten carbon atoms, 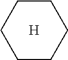
is a cyclohexyl group or a phenyl group, at least two of 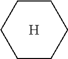
are a phenyl group, and at least one of the at least two phenyl groups has one or more hydrogen group replaced with a fluorine group, and each of Z1, Z2, and Z3 is independently a hydrogen group or a fluorine group.

13. The liquid crystal display device of claim 12, wherein the liquid crystal composition further comprises a compound represented by following Chemical Formula 3 in an amount of about 0.001 weight percent to about 5 weight percent based on the entire weight of the liquid crystal composition. 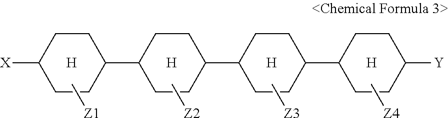
wherein, in Chemical Formula 3, each of X and Y is independently an alkyl group having one to ten carbon atoms, an alkenyl group having two to ten carbon atoms, an alkoxyl group having one to ten carbon atoms, a fluoroalkyl group having one to ten carbon atoms, a fluoroalkenyl group having two to ten carbon atoms or a fluoroalkoxy group having one to ten carbon atoms, 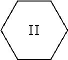
is a cyclohexyl group or a phenyl group, at least one 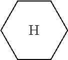
is a phenyl group, and one or more hydrogen group of the at least one phenyl group is replaced with a fluorine group; and each of Z1, Z2, Z3, and Z4 is independently a hydrogen group or a fluorine group.

14. A liquid crystal composition having a dielectric anisotropy of about −1.5 to about −2.5 and a refractive index anisotropy of about 0.090 to about 0.120.

15. The liquid crystal composition of claim 14 comprising:
about 10 weight percent to about 30 weight percent of a compound represented by following Chemical Formula 1, based on a total weight of the liquid crystal composition. 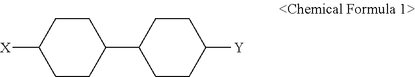
wherein, in Chemical Formula 1, each of X and Y is independently an alkyl group having one to ten carbon atoms, an alkenyl group having two to ten carbon atoms, an alkoxyl group having one to ten carbon atoms, a fluoroalkyl group having one to ten carbon atoms, a fluoroalkenyl group having two to ten carbon atoms or a fluoroalkoxy group having one to ten carbon atoms.

16. The liquid crystal composition of claim 15, further comprising:
a compound represented by following Chemical Formula 2 in an amount of about 0.01 weight percent to about 10 weight percent based on the entire weight of the liquid crystal composition. 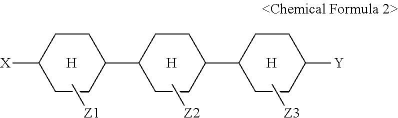
wherein, in Chemical Formula 2, each of X and Y is independently an alkyl group having one to ten carbon atoms, an alkenyl group having two to ten carbon atoms, an alkoxyl group having one to ten carbon atoms, a fluoroalkyl group having one to ten carbon atoms, a fluoroalkenyl group having two to ten carbon atoms or a fluoroalkoxy group having one to ten carbon atoms, 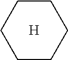
is a cyclohexyl group or a phenyl group, at least two of 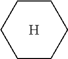
are a phenyl group, and at least one of the at least two phenyl groups has one or more hydrogen group replaced with a fluorine group, and each of Z1, Z2, and Z3 is independently a hydrogen group or a fluorine group.

17. The liquid crystal composition of claim 15, wherein the compound represented by the Chemical Formula 2 is a compound represented by following chemical Formula 8. 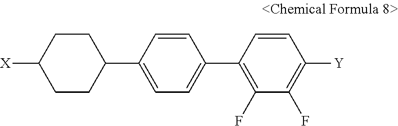
wherein, in Chemical Formula 8, each of X and Y is independently an alkyl group having one to ten carbon atoms, an alkenyl group having two to ten carbon atoms, an alkoxyl group having one to ten carbon atoms, a fluoroalkyl group having one to ten carbon atoms, a fluoroalkenyl group having two to ten carbon atoms or a fluoroalkoxy group having one to ten carbon atoms.

18. The liquid crystal composition of claim 16, further comprising:
a compound represented by following Chemical Formula 3 in an amount of about 0.001 weight percent to about 5 weight percent based on the entire weight of the liquid crystal composition. 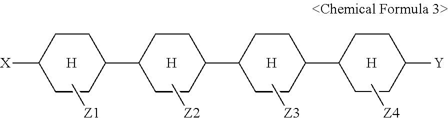
wherein, in Chemical Formula 3, each of X and Y is independently an alkyl group having one to ten carbon atoms, an alkenyl group having two to ten carbon atoms, an alkoxyl group having one to ten carbon atoms, a fluoroalkyl group having one to ten carbon atoms, a fluoroalkenyl group having two to ten carbon atoms or a fluoroalkoxy group having one to ten carbon atoms, 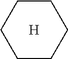
is a cyclohexyl group or a phenyl group, at least one 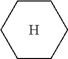
is a phenyl group, and one or more hydrogen group of the at least one phenyl group is replaced with a fluorine group, and each of Z1, Z2, Z3, and Z4 is independently a hydrogen group or a fluorine group.

19. The liquid crystal composition of claim 18, wherein the compound represented by the Chemical Formula 3 is a compound represented by following Chemical Formula 12. 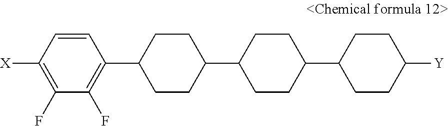
wherein, in chemical formula 12, each of X and Y is independently an alkyl group having one to ten carbon atoms, an alkenyl group having two to ten carbon atoms, an alkoxyl group having one to ten carbon atoms, a fluoroalkyl group having one to ten carbon atoms, a fluoroalkenyl group having two to ten carbon atoms or a fluoroalkoxy group having one to ten carbon atoms.

20. The liquid crystal composition of claim 14 comprising:
a low margin temperature in a range of about −40° C. to about −20° C., and
a high margin temperature in a range of about 90° C. to about 100° C.
